(19) United States
(12) Patent Application Publication
(10) Pub. No.: US 2013/0301575 A1
(43) Pub. Date: Nov. 14, 2013

(54) METHOD FOR ALLOCATING RESOURCE, METHOD FOR TRANSMITTING CHANNEL STATE INFORMATION, BASE STATION AND USER EQUIPMENT

(71) Applicant: FUJITSU LIMITED, Kawasaki-shi (JP)

(72) Inventors: Yi WANG, Beijing (CN); Hua ZHOU, Beijing (CN); Jianming WU, Beijing (CN)

(21) Appl. No.: 13/939,960

(22) Filed: Jul. 11, 2013

Related U.S. Application Data
(63) Continuation of application No. PCT/CN2011/070264, filed on Jan. 14, 2011.

(51) Int. Cl. H04W 72/08

(52) U.S. Cl. CPC H04W 72/08
USPC 370/329

(57) ABSTRACT

A method for transmitting channel state information, base station and user equipment, includes generating by a base station control information for uplink transmission in a user equipment specific search space, the control information includes indication information indicating the user equipment whether to report aperiodic channel state information of related downlink component carriers, and indicating the index number(s) and number of the related downlink component carriers when reporting the aperiodic channel state information of the related downlink component carriers, the index number of modulation and coding scheme and the used resource. The indication information is borne by the bit of a new data indicator in the control information and the bit of an aperiodic channel quality indication request; and transmitting by the base station the control information to the user equipment.

### CROSS-REFERENCE TO RELATED APPLICATIONS

The present application is a continuation of Application No. PCT/CN2011/070264, filed on Jan. 14, 2011, now pending, the contents of which are herein wholly incorporated by reference.

### TECHNICAL FIELD

The present invention relates to the field of radio communication, and in particular to a method for allocating resource, method for transmitting channel state information, base station and user equipment.

### BACKGROUND ART

In a long-term evolution (LTE) system, user equipment (UE) obtains channel state information (CSI) of a downlink by measuring a downlink reference signal, and reports to a base station via an uplink, the CSI comprising a channel quality indicator (CQI) of the downlink, and also information of precoding matrix indicator (PMI) and rank indication (RI) for some modes of downlink transmission. The above CSI, as well as ACK/NACK information and scheduling request (SR), are collectively referred to as uplink control information (UCI). The UCI may contain one piece of the above information only, or more pieces of the above information. The base station selects typical modulation and coding schemes, multi-antenna processing and hybrid automatic repeat request (HARM) on the basis of the UCI reported by the UE, and adaptively adjusts data transmission dynamically.

Currently, the CSI in the UCI may be reported periodically and aperiodically. Here, for the ease of description, the CSI reported periodically is referred to as periodic CSI, and the CSI reported aperiodically is referred to as aperiodic CSI. Generally, UCI containing periodic CSI is transmitted in a physical uplink control channel (PUCCH), and UCI containing aperiodic CSI is transmitted in a physical uplink shared channel (PUSCH), which may be multiplexed with uplink data (such as UL-SCH (uplink shared channel) data), and may also be transmitted separately in a PUSCH when there is no uplink data.

When UE is needed to report aperiodic CSI, the following manner may be used: when a base station needs the user equipment to report aperiodic CSI, the base station transmits to the UE downlink control information (DCI), so as to instruct the UE via the DCI to report aperiodic CSI and allocate corresponding PUSCH resources used for reporting the aperiodic CSI to the UE; when the UE receives the DCI, it reports aperiodic CSI according to the resources indicated in the DCI, and has the CSI contained in the UCI and transmitted to the base station via the PUSCH.

In an LTE system, one bit in a DCI format 0 is used to trigger UE to report aperiodic CSI. In an advanced long-term evolution (LTE-A) system, since the system may support the transmission of multiple component carriers (CCs), and may support at most five CCs at present, two bits in DCI format 0/DCI format 4 are used to trigger UE to report aperiodic CSI, and indicate the indices and the number of the downlink CCs to which the report corresponds.

In the implementation of certain embodiments, this applicant found that following defects exist in the prior art:

In an LTE system, each UE is configured with only one pair of uplink and downlink CCs. In an LTE-A system, when the UE is configured to serve for multiple carriers, i.e. carrier aggregation, 2 bits are configured in the DCI format 0 and the DCI format 4, so as to trigger a report of aperiodic CSI. Where, “00” denotes that no aperiodic CSI is reported, “01/10/11” denotes that aperiodic CSI is reported, indicating three combinations of downlink component carriers. However, for supporting 5 carrier components, it is obvious that these three states are insufficient, thereby limiting the flexibility of the report of aperiodic CSI. Furthermore, as the introduction of the carrier aggregation, the overhead of the report of CSI is substantially increased, thereby affecting the performance of PUSCH data transmission. Currently, there is no method in an LTE system for overcoming the above defects in a simple and effective manner.

It should be noted that the above description of the background art is merely provided for clear and complete explanation of the present invention and for easy understanding by those skilled in the art. And it should not be understood that the above technical solution is known to those skilled in the art as it is described in the background art.

### SUMMARY

Certain embodiments provide a method for transmitting CSI, base station and UE. The base station may use a bit of downlink control information for uplink transmission in a UE-specific search space, such as a new data indicator (NDI), and a bit of an aperiodic channel quality indication (A-CQI) request, to transmit indication information, so that the UE transmits the aperiodic CSI according to the indication information, thereby using effectively the unused bits in the DCI format 0 or DCI format 4, and improving the flexibility of carrier configuration.

An aspect according to certain embodiments provides a method for transmitting CSI, comprising:

generating by a base station control information for uplink transmission in a user equipment specific search space, the control information comprising indication information indicating the user equipment whether to report aperiodic channel state information of related downlink component carriers, and indicating the index number(s) and number of the related downlink component carriers when reporting the aperiodic channel state information of the related downlink component carriers, the index number of modulation and coding scheme and the used resource; wherein the indication information is borne by the bit of a new data indicator in the control information and the bit of an aperiodic channel quality indication request; and

transmitting by the base station the control information to the user equipment such that the user equipment transmits the aperiodic channel state information according to the indication information, the index number of modulation and coding scheme and the used resource contained in the control information.

Another aspect according to certain embodiments provides a method for transmitting CSI, comprising:

receiving by user equipment control information for uplink transmission in a user equipment specific search space transmitted by a base station, the control information comprising indication information indicating the user equipment whether to report aperiodic channel state information of related downlink component carriers, and indicating the index number(s) and number of the related downlink component carriers when reporting the aperiodic channel state information of the related downlink component carriers, the index number of modulation and coding scheme and the used resource; wherein the indication information is borne by the bit of a new data indicator in the control information and the bit of an aperiodic channel quality indication request; and

transmitting by the user equipment the aperiodic channel state information according to the indication information and the index number of modulation and coding scheme and the used resource contained in the control information.

Still another aspect according to certain embodiments provides a base station, comprising:

an information generating unit to generate control information for uplink transmission in a user equipment specific search space, the control information comprising indication information indicating the user equipment whether to report aperiodic channel state information of related downlink component carriers, and indicating the index number(s) and number of the related downlink component carriers when reporting the aperiodic channel state information of the related downlink component carriers, the index number of modulation and coding scheme and the used resource; wherein the indication information is borne by the bit of a new data indicator in the control information and the bit of an aperiodic channel quality indication request; and

a first information transmitting unit to transmit the control information to the user equipment such that the user equipment transmits the aperiodic channel state information according to the indication information, the index number of modulation and coding scheme and the used resource contained in the control information.

Further still another aspect according to certain embodiments provides user equipment, comprising:

an information receiving unit to receive control information for uplink transmission in a user equipment specific search space transmitted by a base station, the control information comprising indication information indicating the user equipment whether to report aperiodic channel state information of related downlink component carriers, and indicating the index number(s) and number of the related downlink component carriers when reporting the aperiodic channel state information of the related downlink component carriers, the index number and the used resource of modulation and coding scheme; wherein the indication information is borne by the bit of a new data indicator in the control information and the bit of an aperiodic channel quality indication request; and

a second information transmitting unit to transmit the aperiodic channel state information according to the indication information and the index number of modulation and coding scheme and the used resource contained in the control information.

Further still another aspect according to certain embodiments provides a storage medium in which a computer-readable program is stored, wherein the computer-readable program enables the computer to carry out the method for transmitting channel state information as described above in a base station.

Further still another aspect according to certain embodiments provides a computer-readable program, wherein when the program is executed in user equipment, the program enables the computer to carry out the method for transmitting channel state information as described above in the user equipment.

Further still another aspect according to certain embodiments provides a storage medium in which a computer-readable program is stored, wherein the computer-readable program enables the computer to carry out the method for transmitting channel state information as described above in the user equipment.

The advantages of certain embodiments herein exist in that the base station may use a bit of downlink control information for uplink transmission in a UE-specific search space, such as a new data indicator (NDI), and a bit of an aperiodic channel quality indication (A-CQI) request, to transmit indication information, so that the UE transmits the aperiodic CSI according to the indication information, thereby using effectively the unused bits in the DCI format 0 or DCI format 4, and improving the flexibility of carrier configuration.

With reference to the following description and drawings, particular embodiments are disclosed in detail, and certain principle and the manners of use are indicated. It should be understood that the scope of the embodiments of the present invention is not limited thereto. The embodiments of the present invention contain many alternations, modifications and equivalents within the spirits and scope of the terms of the appended claims.

Features that are described and/or illustrated with respect to one embodiment may be used in the same way or in a similar way in one or more other embodiments and/or in combination with or instead of the features of the other embodiments.

It should be emphasized that the term “comprises/comprising” when used in this specification is taken to specify the presence of stated features, integers, steps or components but does not preclude the presence or addition of one or more other features, integers, steps, components or groups thereof.

### BRIEF DESCRIPTION OF THE DRAWINGS

The above and other objects, features and advantages of certain embodiments will be apparent from the following detailed description in conjunction with the drawings, in which:

FIG. 1 is a flowchart of the method for transmitting channel state information of the first embodiment;

FIG. 2 is a flowchart of the method for transmitting channel state information of the fourth embodiment;

FIG. 3 is a flowchart of the manner of carrying out step 202 of the fourth embodiment;

FIG. 4 is a flowchart of the manner of carrying out step 303 of the fourth embodiment;

FIG. 5 is a schematic structural diagram of a base station of the fifth embodiment

FIG. 6 is a schematic structural diagram of user equipment of the sixth embodiment;

FIG. 7 is a schematic structural diagram of the second information transmitting unit 602 in FIG. 6;

FIG. 8 is a schematic structural diagram of the second judging unit 703 in FIG. 7;

FIG. 9 is a flowchart of the method for transmitting uplink control information at the base station side of the seventh embodiment; and

FIG. 10 is a flowchart of the method for transmitting uplink control information at the user equipment side of the seventh embodiment.

### DETAILED DESCRIPTION

Various embodiments of the present invention are described as follows with reference to the drawings. These embodiments are illustrative only and are not intended to limit the present invention. For easy understanding of certain principles and embodiments by those skilled in the art, certain embodiments are described taking an LTE-A system of a 10 MHz bandwidth as an example. However, it should be understood that the present invention is not limited to the above system and is applicable to other systems related to aperiodic CSI transmission of multiple carriers.

### Embodiment 1

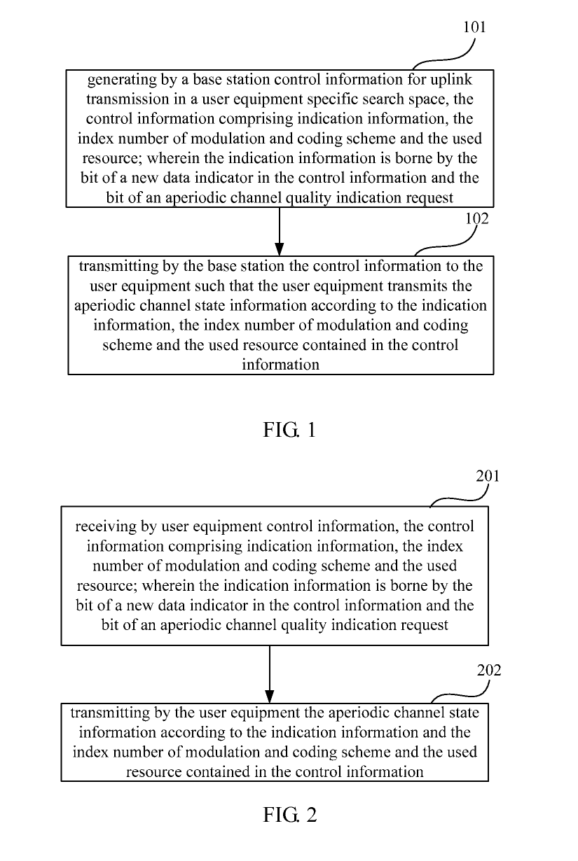

FIG. 1 is a flowchart of the method for transmitting channel state information of the first embodiment. As shown in FIG. 1, the method comprises:

step 101: generating by a base station control information for uplink transmission in a user equipment specific search space, the control information comprising indication information indicating the UE whether to report aperiodic CSI of related downlink CCs, and indicating the index number(s) and number of the related downlink CCs when reporting the aperiodic channel state information of the related downlink CCs, the index number of the modulation and coding scheme and the used resource; wherein the indication information is carried by the bit of an NDI in the control information and the bit of an aperiodic channel quality indication request (A-CQI); and

step 102: transmitting by the base station the control information to the user equipment, such that the user equipment transmits the aperiodic CSI according to the indication information and the index number and the used resource of the modulation and coding scheme contained in the control information.

In this embodiment, the control information generated by the base station is downlink control information (DCI), and the following description is given taking generating DCI as an example.

In this embodiment, the aperiodic CSI may comprise a CQI, and may also comprise PMI and RI for some modes for downlink transmission.

In this embodiment, the aperiodic CSI may be contained in UCI and be transmitted to the base station via a PUSCH; furthermore, ACK/NACK information may also be contained in the UCI together with the CSI for transmission to the base station via a PUSCH. Whether the ACK/NACK information is transmitted together with the aperiodic CSI is similar to the prior art, which shall not be described herein any further. In this way, the base station may select typical modulation and coding scheme, multi-antenna processing and HARQ processes, etc. on the basis of the UCI reported by the UE, and adaptively adjusts data transmission dynamically.

In an LTE-A system, as described in the background art, currently, in order to improve the punctuality and accuracy of UCI, UE may be instructed transmit aperiodic CSI by scheduling the DCI transmitted by a PUSCH, such as the DCI format 0 or DCI format 4, and the resource used in transmitting the aperiodic CSI may be indicated in instructing the UE to transmit the aperiodic CSI.

Table 1 shows carried information and length of the DCI format 0 in an LTE-A FDD system configured with a bandwidth of 10 MHz of an embodiment. Wherein 3 bits carrier indicator may only be configured in the user-specific search space, 1 bit aperiodic SRS request may only be configured in the user-specific search space, 2 bits aperiodic CQI request may only be configured in the user-specific search space, 1 bit is only configured in the common search space or in case of a single carrier, and filling bits are not counted in the payload in the table. Table 2 shows carried information and length of the DCI format 4 in an LTE-A FDD system of an embodiment. Wherein 3 bits carrier indicator may only be configured in the user-specific search space, 2 bits aperiodic CQI request may only be configured in case of multiple carriers, 1 bit is only configured in case of a single carrier, and filling bits are not counted in the payload in the table.

TABLE 1

| | |
|---|---|
| Carrier Indicator | 0/3 |
| Flag for DCI 0/1A | 1 |
| Hopping flag | 1 |
| Resource allocation | 11 |
| Modulation and coding scheme | 5 |
| New data indicator | 1 |
| Power control for PUSCH | 2 |
| DCyclic shift for DMRS and OCC | 3 |
| Aperiodic CQI request | 2 |
| A-SRS request | 1 |
| Multi-cluster flag | 1 |
| Payload | 28/31 |

TABLE 2

| | |
|---|---|
| Carrier Indicator | 0/3 |
| Resource allocation | 11 |
| Power control for PUSCH | 2 |
| Cyclic shift for DMRS and OCC | 3 |
| Aperiodic CQI request | 2 |
| A-SRS request | 2 |
| Multi-cluster flag | 1 |
| Modulation and coding scheme for 1^{st} TB | 5 |
| New data indicator for 1^{st} TB) | 1 |
| Modulation and coding scheme for 2^{nd} TB | 5 |
| New data indicator for 2^{nd} TB | 1 |
| PMI/RI | 3/6 |
| Payload | 36/39/42 |

Furthermore, currently, in using the DCI format 0 or DCI format 4 to trigger aperiodic CSI, when the UE transmits the UCI containing the aperiodic CSI to the base station via the PUSCH, the transmission of the UCI containing the aperiodic CSI in the PUSCH may be classified into: 1) the UCI is separately transmitted in the PUSCH (CQI-only PUSCH), that is, uplink data is not transmitted in transmitting the aperiodic CSI; and 2) the UCI is transmitted together with uplink data in the PUSCH, that is, the uplink data is also transmitted in transmitting the aperiodic CSI.

Wherein, in the first case, the bits of the NDI in the DCI format 0 or DCI format 4 are not needed, and currently, the unused bits of the NDI are not effectively used. As shown in Table 1, in the DCI format 0, the number of the bits of the NDI is 1, and in the DCI format 4, the number of the bits of the NDI is 2.

Hence, in certain embodiments, the base station may use bits of downlink control information for PUSCH transmission in a UE-specific search space, such as the bits of a new data indicator (NDI) and an aperiodic channel quality indication (A-CQI) request, to carry the indication for triggering the aperiodic CSI and index number(s) and number of related downlink CCs, thereby using effectively the unused bits in the DCI format 0 or DCI format 4, and configuring flexibly the downlink carriers.

In this embodiment, in step 101, when the base station determines that the UE should report the aperiodic CSI of the related downlink CCs, the base station may generate the DCI according to the transmission mode and the demand of the system, so as to instruct the UE to report the channel state information (CSI); wherein corresponding indication information may be selected according to a preconfigured corresponding relation between the indication information and a set of the downlink CCs.

In this embodiment, the process of generating the DCI may employ an existing method, which shall not be described herein any further.

In this embodiment, in step 102, the base station may transmit the DCI generated in step 101 in a PDCCH. As described above, the bits of an NDI and an A-CQI request in the DCI format 0 or DCI format 4 may be used to carry the indication for triggering the aperiodic CSI and index number(s) and number of related downlink CCs.

It can be seen from the above embodiment that the base station may use bits of downlink control information for uplink transmission in a UE-specific search space, such as the bits of a new data indicator (NDI), and an aperiodic channel quality indication (A-CQI) request, to transmit indication information, so that the UE transmits the aperiodic CSI according to the indication information, thereby using effectively the unused bits in the DCI format 0 or DCI format 4, and improving the flexibility of carrier configuration.

### Embodiment 2

In this embodiment, on the basis of Embodiment 1, before generating the downlink DCI for uplink transmission by the base station, following steps may also be included: configuring by the base station for the UE a plurality of groups of sets of the related downlink CCs; and notifying the configured plurality of groups of the related downlink CCs to the UE.

In this embodiment, the base station may configure via high layer signaling, such as an RRC protocol; however, it is not limited thereto, and any existing manner may be used for configuration, such as configuring via system information.

In this embodiment, after the base station configures the UE with the plurality groups of sets of downlink CCs, the base station may store correspondingly the indication information and the plural groups of sets of the related downlink component carriers, and in such a case, the base station selects corresponding indication information according to the index number(s) and number of the related downlink CCs when the base station generates the DCI.

### Example 1

for the DCI format 0, as shown in Table 1, three bits consisting of 2 bits of “A-CQI request” and 1 bit of “NDI” in Table 1 may be used to carry the above indication information; wherein the 2 bits of “A-CQI request” are denoted by “XY”, and 1 bit of “NDI” is denoted by “Z”, and vice versa. In such a case, the corresponding states “XYZ” may be “000”, “001”, “010”, “010”, “100”, “101”, “110” and “111”. The above eight states may respectively be used to indicate whether aperiodic CSI is reported and sets of different downlink CCs when indicating to report aperiodic CSI.

### Example 2

for the DCI format 4, as shown in Table 2, three bits consisting of 2 bits of “A-CQI request” and 1 bit of “NDI” in Table 1 may be used to carry the above indication information; wherein the used 1 bit of NDI may be 1 bit of the NDI to which a used transport block (TB) corresponds, and may also be 1 bit of the NDI to which an unused TB corresponds; preferably, 1 bit of the NDI to which a used transport block (TB) corresponds, is used, so as to fully use a used bit.

Table 3 shows a mapping relation between the 3 bits of indication information and corresponding sets of CCs of certain embodiments. As shown in Table 3, in examples 1 and 2, the base station may pre-configure 6 groups of sets of downlink CCs, the 6 groups of sets of downlink CCs comprising one or more downlink CCs; then the configured 6 groups of resources are correspondingly stored with the 3 bits of indication information; and in instructing the UE to transmit aperiodic CSI, the UE is instructed by the indication information to transmit the CSI of one group of CCs of the pre-configured 6 groups of CCs; wherein the 6 groups of downlink CCs may be completely configured via high layer signaling, such as a radio resource control (RRC) protocol.

TABLE 3

| ‘XYZ’ | downlink CCs corresponding to aperiodic CSI transmitted |
|---|---|
| ‘000’ | \ |
| ‘001’ | \ |
| ‘010’ | Downlink CCs to which uplink CCs of the PUSCH indicated by |
| | the DCI correspond, the corresponding relation is configured |
| | via system information (SIB-2), #1 DL CC |
| ‘011’ | First group of sets of downlink CCs configure via a high layer; |
| | #2 DL CCs |
| ‘100’ | Second group of sets of downlink CCs configure via a high |
| | layer; #1 & #2 DL CCs |
| ‘101’ | Third group of sets of downlink CCs configure via a high layer; |
| | #1 & # 2 & #3 DL CCs |
| ‘110’ | Fourth group of sets of downlink CCs configure via a high layer; |
| | #1 & # 2 & #3 & #4 DL CCs |
| ‘111’ | Fifth group of sets of downlink CCs configure via a high layer; |
| | #1 & # 2 & #3 & #4 &#5 DL CCs |

As shown in Table 3, when the 3 bits of “XYZ” are “000” and “001”, it may be indicated that aperiodic CSI is not reported, and only uplink data are transmitted in the PUSCH.

When the 3 bits of “XYZ” are “010” and “011”, it may be indicated that aperiodic CSI is reported, and the number of the downlink CCs contained in the set of downlink CCs is 1; wherein in the set of the related downlink CCs, when the number of the related downlink CCs is 1, the related downlink CC may be a paired downlink CC configured by the uplink CCs of the PUSCH carrying the UCI via a system information block-2 (SIB-2), such as the case to which “010” corresponds in Table 3. Furthermore, the related downlink CC may not be the downlink CC to which the uplink CCs of the PUSCH carrying the aperiodic CSI correspond via an SIB-2 link, such as the case to which “011” corresponds in Table 3.

When the 3 bits of “XYZ” are “100”, “101”, “110” and “111”, it may be indicated that aperiodic CSI is reported, and the numbers of the downlink CCs contained in the set of downlink CCs are 2, 3, 4 and 5, respectively.

Furthermore, indicating index numbers of each of the CCs, such as #1, and #2, etc., is included.

The above corresponding relation may be configured at the base station side, and may be stored at the base station side, for use by the base station in generating the DCI. Furthermore, the base station notifies the corresponding relation to the UE and stores it at the UE side, so that the UE obtains the number and index number(s) of the related downlink CCs according to the indication information after receiving the indication information. The above manner of indication is just an embodiment, and the above indication information may also be configured as actually required.

### Example 3

for the DCI format 4, as shown in Table 2, four bits consisting of 2 bits of “A-CQI request” and 2 bits of “NDI” in Table 2 may be used to carry the above indication information; wherein the 2 bits of “A-CQI request” are denoted by “XY”, and the two bits of “NDI” are denoted by “ZW”, and vice versa. Hence, the corresponding states “XYZW” may be “0000”, “0001”, “0010”, “0011”, “0100”, “0101”, “0110”, “0111”, “1000”, “1001”, “1010”, “01011”, “1100”, “1101”, “1110”, “1111”. The above sixteen states may respectively be used to indicate whether aperiodic CSI is reported and sets of different downlink CCs in indicating to report aperiodic CSI.

Table 4 shows a mapping relation between the 4 bits indication information and corresponding sets of CCs of the embodiment.

TABLE 4

| ‘XYZW’ | Sets of downlink CCs |
|---|---|
| ‘0000’ | \ |
| ‘0001’ | \ |
| ‘0010’ | \ |
| ‘0011’ | \ |
| ‘0100’ | Downlink CCs to which uplink CCs of the PUSCH indicated |
| | by the DCI correspond, the corresponding relation is |
| | configured via system information (SIB-2), # 1 DL CC |
| ‘0101’ | First set of downlink CCs configured via a high layer; |
| | #2 DL CCs |
| ‘0110’ | Second set of downlink CCs configured via a high layer; |
| | #1 & # 2 DL CCs |
| ‘0111’ | Third set of downlink CCs configured via a high layer; |
| | #1 & # 2 & #3 DL CCs |
| ‘1000’ | Third set of downlink CCs configured via a high layer; |
| | #1 & # 2 & #4 DL CCs |
| ‘1001’ | Fourth set of downlink CCs configured via a high layer; |
| | #1 & # 2 & #3 & #4 DL CCs |
| ‘1010’ | Fifth set of downlink CCs configured via a high layer; |
| | #1 & # 2 & #3 & #4 &#5 DL CCs |
| ‘1011’ | Second set of downlink CCs configured via a high |
| | layer; #1 & # 2 DL CCs |
| ‘1100’ | Third set of downlink CCs configured via a high layer; |
| | #1 & # 2 & #3 DL CCs |
| ‘1101’ | Third set of downlink CCs configured via a high layer; |
| | #1 & # 2 & #4 DL CCs |
| ‘1110’ | Fourth set of downlink CCs configured via a high layer; |
| | #1 & # 2 & #3 & #4 DL CCs |
| ‘1111’ | Fifth set of downlink CCs configured via a high layer; |
| | #1 & # 2 & #3 & #4 &#5 DL CCs |

As shown in Table 4, when the 4 bits of “XYZW” are“0000”, “0001”, “0010” and “0011”, it may be indicated that aperiodic CSI is not reported, and only uplink data are transmitted in the PUSCH.

When the 4 bits of “XYZW” are “0100”, “0101”, “0110”, “0111”, “1000”, “1001”, “1010”, “1011”, “1100”, “1101”, “1110”, “1111”, it may be indicated that aperiodic CSI is reported, and the number of the downlink CCs contained in the set of downlink CCs is 1 or more; furthermore, index number(s) of each of the CCs are indicated.

Likewise, such a corresponding relation may be configured at the base station side, and may also be stored at the base station side, for use by the base station in generating the DCI. Furthermore, the base station notifies the corresponding relation to the UE and stores it at the UE side, so that the UE obtains the number and index number(s) of the related downlink CCs according to the indication information after receiving the indication information. The above manner of indication is just an embodiment, and the above indication information may also be configured as actually required.

### Embodiment 3

In an existing system, the report mode of aperiodic CSI corresponds to a transmission mode, and is configured via a high layer, as shown in tables 5 and 6. Table 5 shows a corresponding relation between a CQI report type and a PMI report type, and Table 6 shows a corresponding relation between various transmission modes and reporting modes. Hence, in an existing system, no extra information is needed in the DCI to indicate a report mode of aperiodic CSI. In order to lower the overhead of a report of aperiodic CSI, in this embodiment, the reporting modes of aperiodic CSI of each of the downlink CCs are flexibly varied via DCI.

TABLE 5

| | | Report type of PMI | | |
|---|---|---|---|---|
| | | | Single | |
| | | No PMI | PMI | Multiple PMIs |
| Report type | Bandwidth | | | Mode 1-2 |
| of CQI | (Bandwidth CQI) | | | |
| | User selection | Mode 2-0 | | Mode 2-2 |
| | (Subband CQI) | | | |
| | High layer | Mode 3-0 | Mode 3-1 | |
| | configuration | | | |
| | (Subband CQI) | | | |

TABLE 6

| | Reporting mode |
|---|---|
| Transmission mode 1 | Modes 2-0, 3-0 |
| Transmission mode 2 | Modes 2-0, 3-0 |
| Transmission mode 3 | Modes 2-0, 3-0 |
| Transmission mode 4 | Modes 1-2, 2-2, 3-1 |
| Transmission mode 5 | Modes 3-1 |
| Transmission mode 6 | Modes 1-2, 2-2, 3-1 |
| Transmission mode 7 | Modes 2-0, 3-0 |
| Transmission mode 8 | Modes 1-2, 2-2, 3-1, or 2-0, 3-0 |
| Transmission mode 9 | Modes 1-2, 2-2, 3-1, or 2-0, 3-0 |

On the basis of Embodiment 1, before generating the downlink DCI for uplink transmission by the base station, following steps may also be included: configuring by the base station for the UE a plurality of groups of sets of the related downlink CCs and corresponding reporting modes; and storing correspondingly the indication information and the plurality of groups of sets of the related downlink CCs and corresponding reporting modes; and

when the base station generates the downlink DCI, selecting corresponding indication information according to the index number(s) and the number of the related downlink CCs and the reporting modes.

Furthermore, the configured indication information, and the plurality of groups of sets of the related downlink CCs and corresponding reporting modes may be notified to the UE and stored at the UE side, so that the UE reads the indication information from the DCI after receiving the DCI, and looks up corresponding sets of downlink CCs and reporting modes according to the indication information and said corresponding relation; and the aperiodic CSI of corresponding downlink CCs is transmitted in the reporting modes according to the MSC index numbers in the DCI and the used resources.

In this embodiment, the bits of the NDI and the bits of the aperiodic CQI are respectively used to indicate sets of related downlink CCs and reporting modes.

Furthermore, if the number of the indicated downlink CCs is greater than 1, the reporting modes correspond to corresponding downlink CCs; that is, different downlink CCs may correspond to different reporting modes.

For example, for the DCI format 4, as shown in Table 2, four bits consisting of 2 bits of “A-CQI request” and 2 bits of “NDI” in Table 2 may be used to carry the above indication information; wherein the 2 bits of “A-CQI request” are denoted by “XY”, and the 2 bits of “NDI” are denoted by “ZW”. Hence, the corresponding states “XYZW” may be “0000”, “0001”, “0010”, “0011”, “0100”, “0101”, “0110”, “0111”, “1000”, “1001”, “1010”, “01011”, “1100”, “1101”, “1110”, “1111”. The above sixteen states may respectively be used to indicate whether aperiodic CSI is reported and sets of different downlink CCs and reporting modes in indicating to report aperiodic CSI. Wherein the 2 bits of “A-CQI request” are used to indicate the sets of downlink CCs and the 2 bits of “NDI” are used to indicate the reporting modes.

In this embodiment, the base station may pre-configure 12 groups of sets of downlink CCs and corresponding reporting modes, the 12 groups of sets of downlink CCs comprising one or more downlink CCs; then the configured 12 groups of downlink CCs and the reporting modes are stored correspondingly with the 4 bits indication information; and in instructing the UE to transmit aperiodic CSI, the UE is instructed by the indication information to transmit the CSI and reporting modes of one group of CCs in the pre-configured 12 groups.

Table 7 shows a mapping relation between 4 bits indication information and corresponding sets of CCs and reporting modes.

TABLE 7

| ‘XYZW’ | Sets of downlink CCs | Reporting modes |
|---|---|---|
| ‘0000’ | \ | \ |
| ‘0001’ | \ | \ |
| ‘0010’ | \ | \ |
| ‘0011’ | \ | \ |
| ‘0100’ | Downlink CCs to which uplink CCs | Mode 2-2 |
| | of the PUSCH indicated by the DCI | |
| | correspond, the corresponding | |
| | relation is configured via system | |
| | information (SIB-2), # 1 DL CC | |
| ‘0101’ | First group of sets of downlink CCs | Mode 2-2 |
| | configure via a high layer | |
| | #2 DL CCs | |
| ‘0110’ | Second group of sets of downlink | Mode 2-2 |
| | CCs configure via a high layer | |
| | #1 & # 2 DL CCs | |
| ‘0111’ | Third group of sets of downlink CCs | Mode 2-2 |
| | configure via a high layer | |
| | #1 & # 2 & #3 DL CCs | |
| ‘1000’ | Fourth group of sets of downlink CCs | Mode 2-2 |
| | configure via a high layer | |
| | #1 & # 2 & #4 DL CCs | |
| ‘1001’ | Fifth group of sets of downlink CCs | Mode 2-2 |
| | configure via a high layer | |
| | #1 & # 2 & #3 & #4 DL CCs | |
| ‘1010’ | Sixth group of sets of downlink CCs | #1~#4 DL CCs: |
| | configure via a high layer | Mode 2-2 |
| | #1 & # 2 & #3 & #4 &#5 DL CCs | #5 DL CCs: Mode 2-0 |
| ‘1011’ | Second group of sets of downlink | #1 DL CC: Mode 2-2 |
| | CCs configure via a high layer | #2 DL CC: Mode 1-2 |
| | #1 & # 2 DL CCs | |
| ‘1100’ | Third group of sets of downlink CCs | #1 DL CC: Mode 2-2 |
| | configure via a high layer | #2 & #3 DL CC: |
| | #1 & # 2 & #3 DL CCs | Mode 1-2 |
| ‘1101’ | Fourth group of sets of downlink CCs | #1 DL CC: Mode 2-2 |
| | configure via a high layer | #2 & #4 DL CC: |
| | #1 & # 2 & #4 DL CCs | Mode 1-2 |
| ‘1110’ | Fifth group of sets of downlink CCs | #1 DL CC: Mode 2-2 |
| | configure via a high layer | #2~#4 DL CC: |
| | #1 & # 2 & #3 & #4 DL CCs | Mode 1-2 |
| ‘1111’ | Sixth group of sets of downlink CCs | #1 DL CC: Mode 2-2 |
| | configure via a high layer | #2~#4 DL CC: |
| | #1 & # 2 & #3 & #4 &#5 DL CCs | Mode 1-2 |
| | | #5 DL CC: Mode 2-0 |

It can be seen from Table 7 that when the number of the configured downlink CCs is greater than 1, the configured corresponding reporting modes may be one, or corresponding reporting modes are configured corresponding to different downlink CCs.

It can be seen from the above embodiment that the base station may configure sets of downlink CCs and corresponding reporting modes for the UE, notifies them to the UE and the UE stores them at the UE side. Hence, in generating DCI by the base station, corresponding DCI may be generated according to the pre-configured corresponding relation, so that the UE reads the indication information from the DCI after receiving the DCI, and looks up corresponding sets of downlink CCs and reporting modes according to the indication information and said corresponding relation; and the aperiodic CSI of corresponding downlink CCs is transmitted in the corresponding reporting modes according to the MSC index numbers in the DCI and the used resources.

In the above embodiments 1-3, an existing manner may be used when the base station allocates the used resources to the UE. For example, the maximum number of the RBs allocated to the UE is 4, no matter the number of the downlink CCs is 1 or greater than 1.

Furthermore, the probability of correct receiving the UCI is effectively improved and the limit of scheduling of data transmission is reduced, in order to support the transmission of UCI containing aperiodic CSI in case of multiple carriers. And the base station may also allocate resources according to the number of the related downlink CCs to which the aperiodic CSI needing to be reported by the UE, thereby making the manner of resource allocation flexible, and the transmission of CSI in case of multiple carriers being supported.

Therefore, the method further comprises: allocating used resources to the UE by the base station according to the number of the related downlink CCs. The manner below may be used:

if the base station determines that the UE should report aperiodic CSI of a downlink CC, the maximum number of the RBs allocated by the base station to the UE is a first predetermined number L1; and if the base station determines that the UE should report aperiodic CSI of more than one downlink CCs, the maximum number of the RBs allocated by the base station to the UE is a second predetermined number L2;

wherein the second numerical value L2 is greater than the first numerical value L1, the first numerical value L1 and the second numerical value L2 are determined according to a channel coding rate (CCR), and the CCR is made to be within a predetermined range by determining the first number L1 and the second number L2. Of course, the use of the first number L1 and the second number L2 may cause the CCR to exceed a rational range; however, such a case occurs seldom. Hence, it is generally deemed that the first number L1 and the second number L2 are rational.

The first number L1 and the second number L2 shall be described below taking one downlink CC and 2 downlink CCs as examples.

In case of one downlink CC, similar to that in an LTE system, if the predetermined CCR is less than one third, the maximum of the first number L1 is 4; that is, the CCR may be made in a rational range if only the base station allocates at most 4 RBs for the UE.

In case of multiple downlink CCs, such as 2 downlink CCs, for example, if the predetermined CCR is still one third, the second number L2 may be any number greater than 4. However, in this embodiment, in order that normal transmission of other data or information in the system is not affected, when the UCI containing the aperiodic CSI is transmitted, the second number L2 should be made as small as possible, while ensuring the base station correctly receives the UCI.

Table 8 shows numerical values of corresponding CCRs in transmitting various UCI and sounding reference signals (SRSs) in case of three typical bit lengths (that is, the payloads are 100, 136, 144) of aperiodic CSI when the number of downlink CCs is 2 and the number of the allocated resources is 4. Table 9 shows numerical values of corresponding CCRs in transmitting various UCI and SRSs in case of three typical bit lengths of aperiodic CSI when the number of downlink CCs is 2 and the number of the allocated resources is 5.

Table 10 shows numerical values of corresponding CCRs in transmitting various UCI and SRSs in case of three typical bit lengths of aperiodic CSI when the number of downlink CCs is 2 and the number of the allocated resources is 6.

As seen in Table 8, if the number of downlink CCs is 2 and 4 RBs are still allocated, when the payload of the aperiodic CSI is 136 and 144, in transmitting CQI+A/N+RI or CQI+A/N+SRS+RI, the CCR exceeds the predetermined range; and when the payload of the aperiodic CSI is 100, in transmitting CQI+A/N+SRS+RI, the CCR exceeds the predetermined range. Thus, the base station is not ensured to correctly receive the UCI.

TABLE 8

| | | | | | | | CQI + | CQI + A/ |
|---|---|---|---|---|---|---|---|---|
| | | CQI + | CQI + | CQI + | CQI + A/ | CQI + RI + | A/N + | N + RI + |
| Payload | CQI | SRS | A/N | RI | N + SRS | SRS | RI | SRS |
| 100 | 0.087 | 0.095 | 0.13 | 0.13 | 0.149 | 0.149 | 0.26 | 0.347 |
| 136 | 0.118 | 0.129 | 0.177 | 0.177 | 0.202 | 0.202 | 0.354 | 0.472 |
| 144 | 0.125 | 0.136 | 0.188 | 0.188 | 0.214 | 0.214 | 0.375 | 0.5 |

TABLE 9

| | | CQI + | CQI + | CQI + | CQI + A/ | CQI + RI + | CQI + A/ | CQI + A/ |
|---|---|---|---|---|---|---|---|---|
| Payload | CQI | SRS | A/N | RI | N + SRS | SRS | N + RI | N + RI + SRS |
| 100 | 0.069 | 0.076 | 0.104 | 0.104 | 0.119 | 0.119 | 0.208 | 0.278 |
| 136 | 0.094 | 0.103 | 0.142 | 0.142 | 0.162 | 0.162 | 0.283 | 0.378 |
| 144 | 0.1 | 0.109 | 0.15 | 0.15 | 0.171 | 0.171 | 0.3 | 0.4 |

TABLE 10

| | | CQI + | CQI + | CQI + | CQI + A/ | CQI + RI + | CQI + A/ | CQI + A/ |
|---|---|---|---|---|---|---|---|---|
| Payload | CQI | SRS | A/N | RI | N + SRS | SRS | N + RI | N + RI + SRS |
| 100 | 0.058 | 0.063 | 0.087 | 0.087 | 0.099 | 0.099 | 0.174 | 0.232 |
| 136 | 0.079 | 0.086 | 0.118 | 0.118 | 0.135 | 0.135 | 0.236 | 0.315 |
| 144 | 0.083 | 0.091 | 0.125 | 0.125 | 0.143 | 0.143 | 0.25 | 0.333 |

As seen in Table 9, if RB=5, the CCRs exceed the predetermined range only when the payload of the aperiodic CSI is 136 and 144 and CQI+A/N+SRS+RI is transmitted; however, transmission of CQI+A/N+SRS+RI occurs seldom. Hence, it is generally deemed that RB=5 is rational.

As seen in Table 10, if RB=6, the CCRs are within the predetermined range.

It can be seen from above that in the determination of the number of the allocated resources, both making the CCRs in a rational range and making the number of the resources as small as possible are taken into consideration, so as to alleviate the effect on the transmission of other resources. It has been proved that in case of 2 CCs, it is optimal that the maximum value of the second number L2 is 5 or 6.

The above description is given for the case of 2 CCs. And for cases of more than 2 CCs, the method for determining the second number L2 is similar to what is described above. Furthermore, an existing algorithm may be employed for calculating the CCRs, which shall not be described herein any further.

It can be seen from the above embodiment that the base station may allocate resources according to the number of the related downlink CCs to which the aperiodic CSI needing to be reported by the UE, thereby making the manner of resource allocation flexible, and the transmission of CSI in case of multiple carriers being supported.

### Embodiment 4

FIG. 2 is a flowchart of the method for transmitting channel state information of the fourth embodiment. The method comprises:

step 201: receiving by UE control information for uplink transmission in a UE-specific search space transmitted by a base station, the control information comprising indication information indicating the UE whether to report aperiodic CSI of related downlink component carriers, and indicating the index number(s) and number of the related downlink component carriers in reporting the aperiodic CSI of the related downlink component carriers, and the index number of the modulation and coding scheme (MCS) and the used resource; wherein the indication information is carried by the bit of a new data indicator in the control information and the bit of an aperiodic channel quality indication request;

wherein in step 201, the control information received by the UE may be DCI, the DCI may be transmitted by the base station via a PDCCH, and the UE may read the indication information, the index number of the MCS and the used resource in the DCI;

step 202: transmitting by the UE the aperiodic CSI according to the indication information and the index number of the MCS and the used resource contained in the control information.

Following description is given taking that the UE receives DCI as an example.

Wherein, the UE reports the aperiodic CSI via UCI, and UCI being transmitted to the base station via a PUSCH. The UCI transmitted in the PUSCH may be classified into: 1) the UCI is separately transmitted in the PUSCH (CQI-only PUSCH), that is, uplink data is not transmitted in transmitting the aperiodic CSI; and 2) the UCI is transmitted together with uplink data in the PUSCH, that is, the uplink data is also transmitted in transmitting the aperiodic CSI. Wherein, which manner is used to transmit the UCI is judged according to a specific combination of the indication information, the MCS and the number of the used resources, and the process of which shall be described below in detail.

Following description is given taking that the UCI containing the CSI is transmitted to the base station via a PUSCH. Furthermore, ACK/NACK information may be contained in the UCI together with the aperiodic CSI for transmitting to the base station. Whether the ACK/NACK information is transmitted together with the aperiodic CSI is similar to the prior art, which shall not be described herein any further.

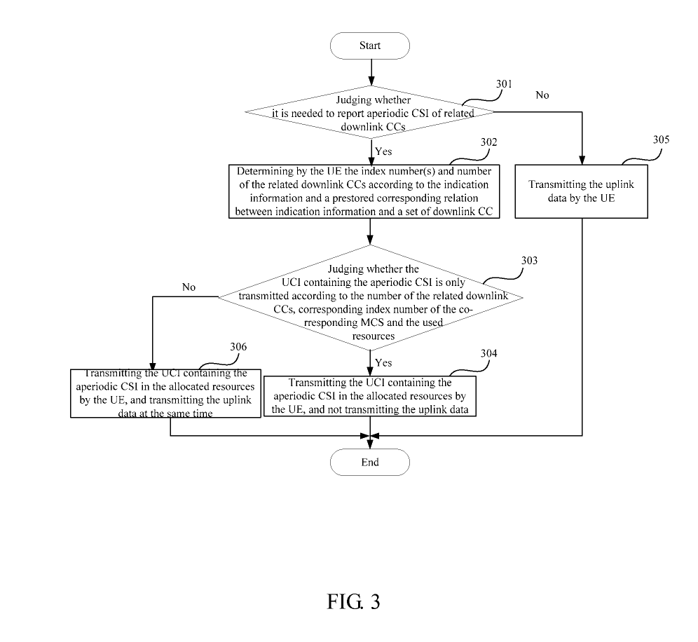

FIG. 3 is a flowchart of the manner of carrying out step 202 of the fourth embodiment. As shown in FIG. 3, the UE transmits the aperiodic CSI according to the indication information contained in the DCI, the index number of the MCS and the used resources, in a manner as follows:

step 301: judging by the UE according to the indication information in the received DCI whether aperiodic CSI of related downlink CCs needs to be reported; if the result of judgment is positive, executing step 302, and if the result of judgment is negative, executing step 305;

wherein for DCI format 0/4, the indication information may be carried by 2 bits of “CQI request” and 1 bit of “NDI”; and for DCI format 4, the indication information may be carried by 2 bits of “CQI request” and 2 bits of “NDI”;

the UE may determine whether to report the aperiodic CSI of related downlink CCs according to the indication information and a prestored corresponding relation between indication information and sets of downlink CCs;

for example, according to the corresponding relation shown in Table 3 or Table 4, as shown in Table 3, if the indication information “XYZ” is “000” and “001”, it may indicate that no aperiodic CSI is reported, and uplink data are only transmitted in the PUSCH;

and if the indication information “XYZ” is“010”, “010”, “100”, “101”, “110” and “111”, it may indicate that aperiodic CSI is reported, and the number and index number(s) of the related downlink CCs may be known according to Table 3;

step 302: if the result of judgment in step 301 is that the aperiodic CSI needs to be reported, determining the index number(s) and number of the related downlink CCs by the UE according to the indication information and the prestored corresponding relation between indication information and sets of downlink CCs;

for example, it may be determined according to the corresponding relation in Table 3 or Table 4 and particular indication information; for example, as shown in Table 3, if it is determined that the indication information is “111”, it can be known that UCI containing aperiodic CSI of 5 downlink CCs is transmitted and the index number(s) of the downlink CCs are 1-5;

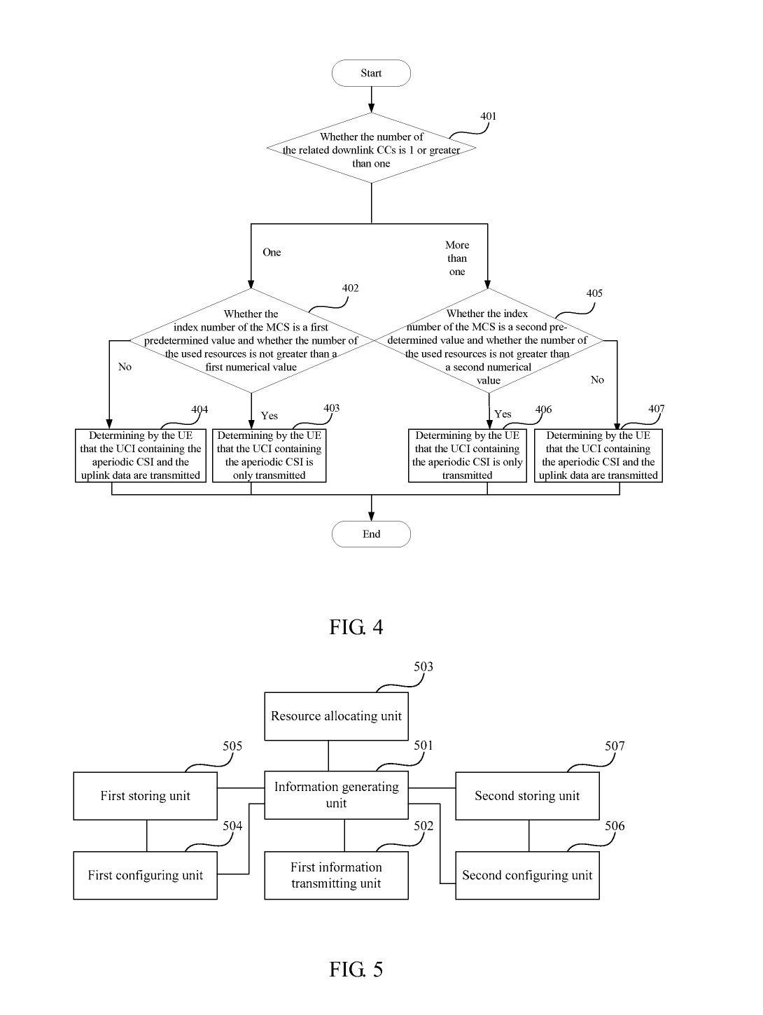

step 303: judging whether the UCI containing the aperiodic CSI is only transmitted according to the determined number of the related downlink CCs, corresponding index number of the corresponding MCS and the used resources; and if the result of judgment is that the UCI is transmitted only, executing step 304; otherwise, executing step 306;

wherein the detailed process of judgment is shown in FIG. 4 and shall be described below; step 304: if the result of judgment in step 303 is positive, transmitting the UCI containing the aperiodic CSI by the UE in the resources allocated by the base station for the UE via the PUSCH at a predetermined time, and transmitting no uplink data at the same time;

wherein the UE transmits the UCI containing the aperiodic CSI in the used resources allocated by the base station for the UE, and ACK/NACK information may be contained in the UCI for being transmitted together with the aperiodic CSI;

step 305: if the result of judgment in step 301 is negative, transmitting the uplink data only by the UE in the PUSCH; and

step 306: if the result of judgment in step 303 is negative, transmitting the UCI containing the aperiodic CSI and uplink data by the UE in the resources allocated by the base station for the UE;

wherein in transmitting the UCI containing the aperiodic CSI and the uplink data, the UCI containing the aperiodic CSI may be transmitted to the base station together with the uplink data via the PUSCH in a multiplexing manner; that is, the UCI for transmitting the aperiodic CSI uses part of the resources of the uplink data, and this part of resources needs not to be indicated via extra signalling, which may be the resources used in such a case agreed in advance by the UE and the base station.

FIG. 4 is a flowchart of the manner of carrying out step 303 of the fourth embodiment. When the base station allocate resources for the UE according to the number of the downlink CCs, as shown in FIG. 4, following steps are included:

step 401: judging whether the number of the related downlink CCs is 1 or greater than 1; if the number is judged as 1, executing step 402, if the number is judged as greater than 1, executing step 405;

step 402: when the number of the related downlink CCs is 1, further judging whether the index of the MCS is a first predetermined value and the number of the used resources is less than a first numerical value; and if the result of judgment is positive, executing step 403; otherwise, executing step 404;

wherein the index of the MCS is 29, and the number of the used resources is not greater than 4;

step 403: if the result of judgment in step 402 is positive, determining to transmit only the UCI containing the aperiodic CSI and not to transmit uplink data;

step 404: if the result of judgment in step 402 is negative, determining to transmit the UCI containing the aperiodic CSI and the uplink data;

step 405: if the result of judgment in step 401 is that the number of the downlink CCs is greater than 1, further judging whether the index of the MCS is a second predetermined value and the number of the used resources is less than a second numerical value; and if the result of judgment is positive, executing step 406; otherwise, executing step 405;

wherein the index of the MCS is 29, and the number of the used resources is not greater than RB=L; and wherein the second numerical value is greater than the first numerical value, and may preferably be 5 or 6;

step 406: if the result of judgment in step 405 is positive, determining to transmit only the UCI containing the aperiodic CSI and not to transmit uplink data; and

step 407: if the result of judgment in step 405 is negative, determining to transmit the UCI containing the aperiodic CSI and the uplink data.

It can be seen from the above embodiment that the UE may determine the number of the related downlink CCs according to the received indication information, and hence determine the transmission of the aperiodic CSI according to the number of the downlink CCs, the MCS and the used resources, and the aperiodic CSI may be contained in the UCI for transmission; and the method is applicable to the transmission of UCI in case of multiple carriers.

Furthermore, an existing manner may be used in executing step 303. For example, when the number of the downlink CCs is 1 or greater than 1, the maximum number of the allocated RBs is 4. Hence, judging whether the UCI containing the aperiodic CSI is only transmitted according to the determined number of the related downlink CCs, corresponding index number of the corresponding MCS and the used resources in step 303 may use the manner as follows:

judging whether the index of the MCS is 29 and whether the number of the used resources is less than or equal to 4; if the result of judgment is positive, determining to transmit only the UCI containing the aperiodic CSI and transmit no uplink data; and if the result of judgment is negative, determining to transmit the UCI containing the aperiodic CSI and the uplink data.

In the above embodiment, the description is given taking that the indication information comprises the index number(s) and number of the related downlink CCs as an example. Furthermore, in this embodiment, the indication information further comprises a report mode indicating aperiodic CSI; furthermore, when number of the related downlink CCs is greater than 1, different downlink CCs may correspond to different reporting modes.

In such a case, in step 302, if the result of judgment in step 301 is that the aperiodic CSI needs to be reported, the UE determines the index number(s) and number of the related downlink CCs and the reporting modes according to the indication information, the prestored corresponding relation between indication information and sets of downlink CCs and corresponding reporting modes;

in step 305, if the result of judgment is that the uplink data are not transmitted in transmitting the aperiodic CSI, transmitting the aperiodic CSI by the UE in the used resources allocated by the base station for the UE according to the report mode;

in step 306, if the result of judgment is that the uplink data are also transmitted in transmitting the aperiodic CSI, transmitting the aperiodic CSI and the uplink data by the UE in the resources allocated by the base station for the UE according to the report mode.

It can be seen from the above embodiment that the base station may configure the UE with sets of downlink CCs, or furthermore, corresponding reporting modes, and notify them to the UE and store them at the UE side. Hence, when the base station generates DCI, corresponding DCI may be generated according to a pre-configured corresponding relation, so that the UE reads the indication information from the DCI after receiving the DCI, looks up sets of corresponding downlink CCs and reporting modes according to the indication information and said corresponding relation, and then transmits aperiodic CSI of corresponding downlink CCs in a corresponding report mode according to the index number of the MCS in the DCI and the used resources.

Certain embodiments further provide a base station and UE, as described in embodiments 5 and 6 below. As the principle of the base station and UE for solving problems is similar to that of the above method for transmitting channel state information based on a base station and UE of embodiments 1-4, the implementation of the method may be referred to for the implementation of the base station and UE, and the repeated parts shall not be described any further.

### Embodiment 5

An embodiment provides a base station. As shown in FIG. 5, the base station comprises: an information generating unit 501 and a first information transmitting unit 502; wherein

the information generating unit 501 is configured to generate control information for uplink transmission in a UE-specific search space, the control information comprising indication information indicating the UE whether to report aperiodic CSI of related downlink CCs, and indicating the index number(s) and number of the related downlink CCs when reporting the aperiodic channel state information of the related downlink CCs, the index number of the modulation and coding scheme and the used resource; wherein the indication information is carried by the bit of an NDI in the control information and the bit of an aperiodic channel quality indication request (A-CQI); and

the first information transmitting unit 502 is configured to transmit the control information to the UE such that the UE transmits the aperiodic CSI according to the indication information and the index number and the used resource of the MCS contained in the control information.

Wherein the control information generated by the information generating unit 501 may be downlink control information (DCI), and the following description is given taking generating the DCI as an example.

The manner of generating the DCI by the information generating unit 501 is as described in Embodiment 1, which shall not be described herein any further.

In this embodiment, the base station further comprises a resource allocating unit 503 configured to allocate resources for the UE according to the number of the related downlink CCs. In particular, the resource allocating unit 503 may comprise a first resource allocating unit and a second resource allocating unit; wherein the first resource allocating unit is configured to allocate resources with a maximum number being a first predetermined numerical value L1 when the UE is needed to report aperiodic CSI of one downlink CC, and the second resource allocating unit is configured to allocate resources with a maximum number being a second predetermined numerical value L2 when the UE is needed to report aperiodic CSI of more than one downlink CCs; wherein the second numerical value L2 is greater than the first numerical value L1, and the first numerical value L1 and the second numerical value L2 are determined according to a CCR. Particular determination of the first numerical value L1 and the second numerical value L2 is as described in embodiments 1-3, which shall not be described herein any further.

It can be seen from above embodiment that as the base station may allocate resources according to the number of downlink CCs, the manner of resource allocation is made flexible, and the transmission of UCI in case of multiple carriers is supported.

As shown in FIG. 5, the base station further comprises a first configuring unit 504 and a first storing unit 505; wherein the first configuring unit 504 is configured to configure for the UE a plural groups of sets of the related downlink CCs, and the first storing unit 505 is configured to store correspondingly the indication information and the plurality of groups of sets of the related downlink CCs, as shown in tables 3 and 4 of Embodiment 2.

And in generating the DCI, the information generating unit 501 selects corresponding indication information according to index number(s) and the number of the related downlink CCs.

Furthermore, the base station configures reporting modes, in addition to the above information, so as to save the overhead of high-layer signalling of the base station. The indication information further comprises a reporting mode of the aperiodic CSI, or, when the number of the related downlink CCs is more than 1, comprises indicating a reporting mode of the aperiodic CSI corresponding to the related downlink component carriers, as shown in Table 5 of Embodiment 3.

In such a case, as shown in FIG. 5, the base station further comprises a second configuring unit 506 and a second storing unit 507; wherein,

the second configuring unit 506 is configured to configure the UE a plurality of groups of sets of the related downlink CCs and corresponding reporting modes, and the second storing unit 507 is configured to store correspondingly the indication information and the plurality of groups of sets of the related downlink CCs and corresponding reporting modes;

and the information generating unit 501 is further configured to select corresponding indication information according to the index number(s), number and corresponding reporting modes of the related downlink CCs in generating the DCI.

In the above embodiment, the base station may further comprise an information notifying unit (not shown) configured to notify the UE of the configured information in the first configuring unit 504 and the second configuring unit 506 or the resource allocating unit 503, and store the configured information in the UE.

It can be seen from the above embodiment that in determining that the UE is needed to report the aperiodic CSI of the related downlink CCs, the information generating unit 501 may select corresponding indication information, MCS and used resources to generate DCI as actually required; wherein indication information is transmitted by using the DCI for uplink transmission in a UE-specific search space, such as the bits of a NDI and an A-CQI request to transmit indication information, and then transmit the above information to the UE. In this way, the unused bits in the DCI format 0 or DCI format 4 may be effectively used, and the flexibility of carrier configuration is improved. Furthermore, as the base station may allocate resources according to the number of downlink CCs, the manner of resource allocation is made flexible, and the transmission of UCI in case of multiple carriers is supported.

### Embodiment 6

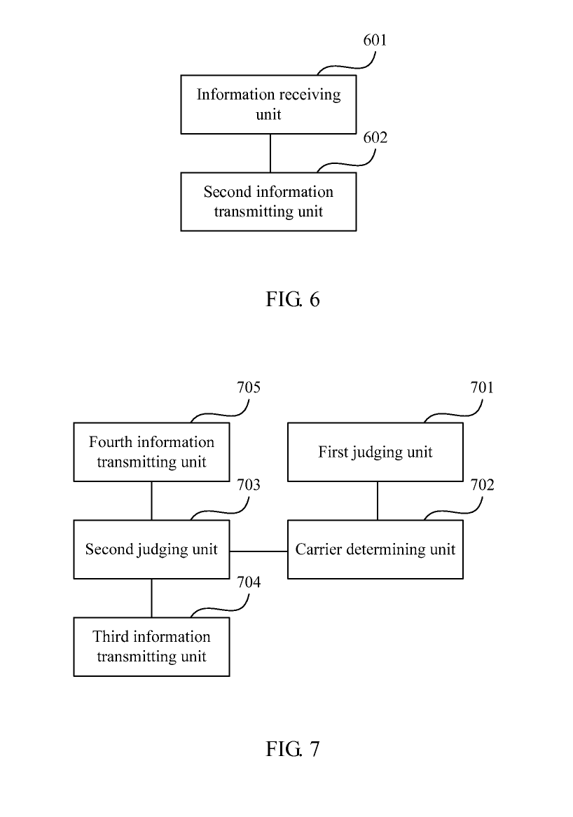

FIG. 6 is a schematic structural diagram of the UE of the sixth embodiment. As shown in FIG. 6, the UE comprises: an information receiving unit 601 and a second information transmitting unit 602; wherein,

the information receiving unit 601 is configured to receive control information for uplink transmission in a UE-specific search space transmitted by a base station, the control information comprising indication information indicating the UE whether to report aperiodic CSI of related downlink CCs, and indicating the index number(s) and number of the related downlink CCs in reporting the aperiodic CSI of the related downlink component carriers, and the index number of the modulation and coding scheme (MCS) and the used resource; wherein the indication information is carried by the bit of a NDI in the control information and the bit of an A-CQI request; and

the second information transmitting unit 602 is configured to transmit the aperiodic C SI according to the indication information and the index number of the MCS and the used resource contained in the control information; wherein the manner described in Embodiment 4 may be employed as the manner of transmitting the CSI by the second information transmitting unit 602.

Wherein the control information received by the information receiving unit 601 may be DCI, and the following description is given taking that the control information is DCI as an example.

FIG. 7 is a schematic structural diagram of the second information transmitting unit 602 in FIG. 6. As shown in FIG. 7, the second information transmitting unit 602 comprises:

a first judging unit 701 configured to judge whether CSI of related downlink CCs needs to be reported according to indication information;

a carrier determining unit 702 configured to determine the index number(s) and the number of the related downlink CCs according to the indication information and a prestored corresponding relation between indication information and a set of the downlink CCs, if the result of judgment of the first judging unit 701 is that the aperiodic CSI needs to be reported;

a second judging unit 703 configured to judge whether to transmit only the aperiodic CSI according to the number of the related downlink CCs and the index number of the corresponding MCS and the used resource determined by the carrier determining unit 702;

a third information transmitting unit 704 configured to transmit the aperiodic CSI in the used resources allocated by the base station for the UE if the result of judgment of the second judging unit 703 is that uplink data are not transmitted in transmitting the aperiodic CSI; and

a fourth information transmitting unit 705 configured to transmit the aperiodic CSI and uplink data in the used resources allocated by the base station for the UE if the result of judgment of the second judging unit 703 is that not only the aperiodic CSI but also uplink data are transmitted.

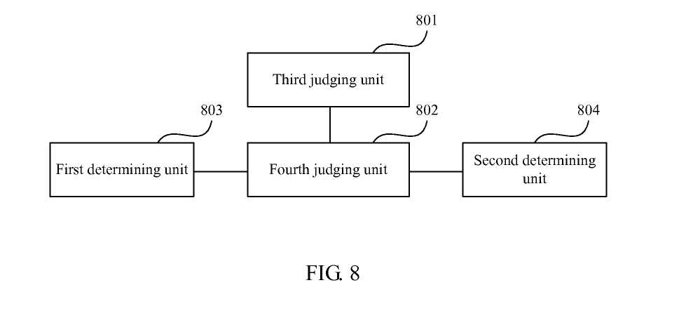

FIG. 8 is a schematic structural diagram of the second judging unit 703 in FIG. 7. When the base station allocates corresponding resources according to the number of the downlink CCs, as shown in FIG. 8, the second judging unit 703 comprises:

a third judging unit 801 configured to judge whether the number of the downlink CCs is 1 or greater than 1;

a fourth judging unit 802 configured to further judge whether the index number of the MCS contained in the DCI is a predetermined index number, and whether the number of the used resources is less than or equal to a first predetermined numerical value, if the result of judgment of the third judging unit 801 is that the number of the downlink CCs is 1, or configured to further judge whether the index number of the MCS contained in the DCI is a predetermined index number, and whether the number of the used resources is less than or equal to a second predetermined numerical value, if the result of judgment of the third judging unit 801 is that the number of the downlink CCs is more than 1; wherein the second numerical value is greater than the first numerical value, and the first numerical value and the second numerical value are determined according to a CCR;

a first determining unit 803 configured to determine that uplink data are not transmitted in transmitting the aperiodic CSI if the result of judgment of the fourth judging unit 802 is positive; and

a second determining unit 804 configured to determine that uplink data are also transmitted in transmitting the aperiodic CSI if the result of judgment of the fourth judging unit 802 is negative.

Wherein, the UE may report the aperiodic CSI via UCI, the UCI being transmitted to the base station via a PUSCH. The manner described in Embodiment 4 may be used as a manner of carrying out the functional units in the second information transmitting unit 602, which shall not described herein any further.

It can be seen from the above embodiment that the UE may determine the number of the related downlink CCs according to the received indication information, and hence determine the transmission of the aperiodic CSI according to the number of the downlink CCs, the MCS and the used resources; and the method is applicable to the transmission of UCI in case of multiple carriers, ensuring the rate of correctness of receiving the UCI by the base station, and reducing the limit of scheduling of data transmission of the base station.

In this embodiment, the indication information further comprises indicating a reporting mode of the aperiodic CSI, or, when the number of the related downlink CCs is more than 1, comprises indicating a reporting mode of the aperiodic CSI corresponding to the related downlink CCs.

Thus, the carrier determining unit 702 may be further configured to determine the index number(s) and the number of the related downlink CCs and reporting modes according to the indication information and a prestored corresponding relation between indication information, sets of downlink CCs and reporting modes, if the result of judgment of the first judging unit 701 is that the aperiodic CSI needs to be reported.

The third information transmitting unit 704 may be further configured to transmit the aperiodic CSI according to the reporting mode in the used resources allocated by the base station for the UE, if the result of judgment of the second judging unit 703 is that no uplink data is transmitted in transmitting the aperiodic CSI.

The fourth information transmitting unit 705 may be further configured to transmit the aperiodic CSI and the uplink data by the UE according to the reporting mode in the used resources allocated by the base station for the UE, if the result of judgment of the second judging unit 703 is that not only the aperiodic CSI but also the uplink data are transmitted.

And the information receiving unit 601 of the UE may be further configured to receive configuration information transmitted by the base station, i.e. resource configuration information and a corresponding relation between indication information and sets of carriers or further comprising reporting modes, and may further comprise a storing unit (not shown) configured to store a table of corresponding relation between indication information and sets of carriers or further comprising reporting modes, for use by the UE.

It can be seen from the above embodiment that the UE may determine the number of the related downlink CCs according to the received indication information, or may further learn the reporting modes, and hence determine the transmission of the aperiodic CSI according to the information contained in the indication information, the MCS and the used resources; and the method is applicable to the transmission of UCI in case of multiple carriers, ensuring the rate of correctness of receiving the UCI by the base station, and reducing the limit of scheduling of data transmission of the base station.

The above embodiment is applicable to an LTE-A system. The embodiment shall be described below taking that aperiodic CSI is reported via UCI as an example; wherein the index number of the MCS is 29, the number of RBs used in case of one downlink CC, that is, the first numerical value L1, is less than or equal to 4, and the number of RBs used in case of two downlink CCs, that is, the second numerical value L2, is less than or equal to 5.

Following description is given taking that the UE is configured with a plurality groups of sets of related downlink CCs as an example. Wherein, the control information generated by the base station is DCI.

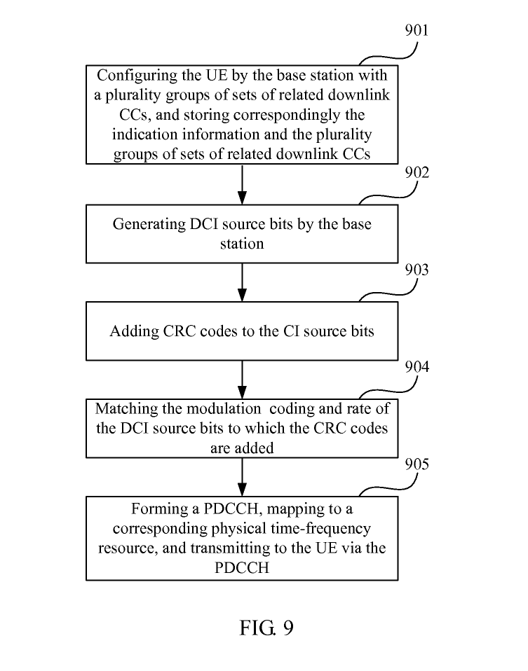

FIG. 9 is a flowchart of the method for transmitting uplink control information at the base station side of the seventh embodiment. As shown in FIG. 9, the method comprises:

step 901: configuring the UE by the base station with a plurality of groups of sets of related downlink CCs, and storing correspondingly the indication information and the plurality of groups of sets of related downlink CCs;

as shown in Table 3 or Table 4, the embodiment shall be described taking Table 3 as an example;

step 902: when it is determined by the base station that the UE is needed to report the aperiodic CSI on the related downlink CCs, if it is determined that the aperiodic CSI on the downlink CCs 1 and 2, generating corresponding DCI source bits by the base station according to the transmission modes and the requirements of the system, the process of generation is as that in the prior art, and shall not be described herein any further;

wherein the DCI may comprise indication information “100”, which may be carried by 2 bits of a CQI request and 1 bit of an NDI in the DCI format 0 or DCI format 4, the index number of the MCS is 29, and the number of the RBs L2 is 5;

step 903: adding cyclic redundancy check (CRC) codes by the base station to the generated DCI source bits;

step 904: matching the modulation, coding and rate of the DCI source bits to which the CRC codes are added;

step 905: forming a PDCCH, mapping to a corresponding physical time-frequency resource, and transmitting to the UE via the PDCCH.

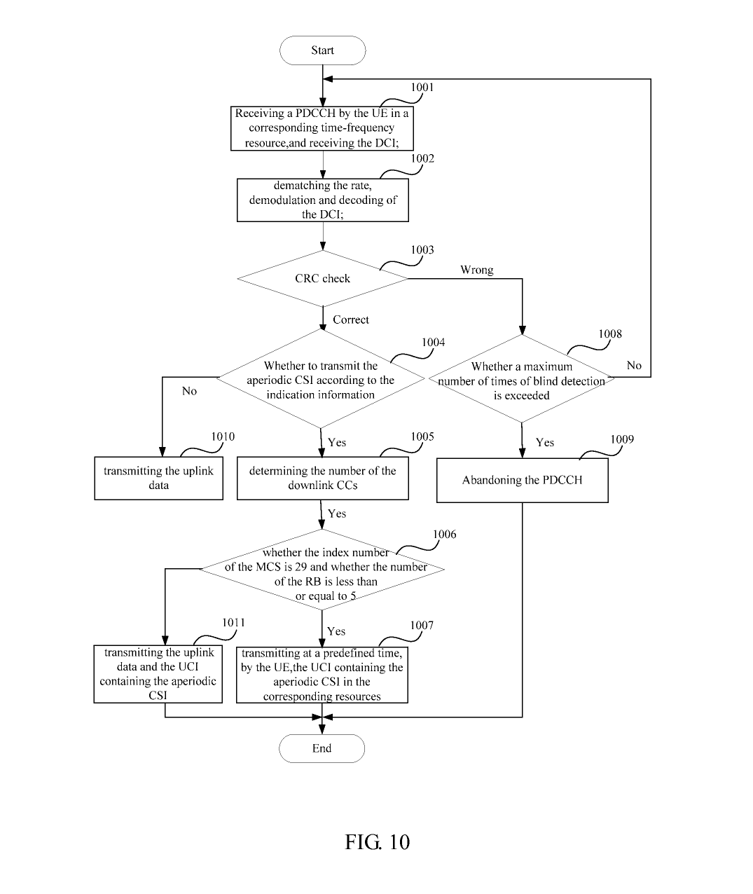

FIG. 10 is a flowchart of the method for transmitting uplink control information at the UE side of an embodiment. The UE first detects possible DCI according to the transmission modes, and then determines whether to transmit UCI containing aperiodic CSI, or whether to transmit only UCI containing aperiodic CSI, according to the detected DCI. As shown in FIG. 10, the method comprises:

step 1001: receiving by the UE the PDCCH on the corresponding time-frequency resource, and receiving the DCI;

step 1002: dematching the rate, demodulation and decoding of the DCI;

step 1003: judging whether the CRC is correct; and executing step 1004, if the result of judgment is positive, otherwise, executing step 1008;

step 1004: further judging whether to transmit the UCI containing the aperiodic C SI according to the read indication information in the DCI, the index number of the modulation and coding scheme and the used resources, if the result of judgment of step 1003 is that the CRC is correct; and executing step 1005 if the result of judgment is to transmit the UCI, otherwise, executing step 1010;

wherein, “11” indicates that the UCI containing the aperiodic CSI of the downlink CCs with the index numbers 1 and 2 is transmitted;

step 1005: further determining the number of the downlink CCs, if the result of judgment in step 1004 is positive;

it can be seen from above that the number of the downlink CCs is 2;

step 1006: further judging whether the index number of the MCS is 29 and whether the number of the used resources is less than or equal to 5 according to the number of the downlink

CCs; and executing step 1006, if the result of judgment is positive, otherwise, executing step 1011;

in this embodiment, if L2 is 5 and the index number of the MCS is 29, the result of judgment is positive;

step 1007: transmitting at a predefined time, by the UE, the UCI containing the aperiodic CSI in the resources which are allocated to the UE by the base station, with the UCI containing the aperiodic CSI being only transmitted, and the uplink data being not transmitted, if the result of judgement in step 1005 is positive;

step 1008: further determining whether the CRC exceeds a maximum blink check time, if the result of judgment of step 1003 is that the CRC is wrong; and executing step 1009, if the result of determining is positive, otherwise, returning back to step 1001;

step 1009: abandoning the PDCCH and terminating the process, if the result of judgment in step 1008 is positive;

step 1010: transmitting the uplink data via the PUSCH only and then terminating the process (not shown), if the result of judgment in step 1004 is negative; and

step 1011: transmitting the uplink data and the UCI containing the aperiodic CSI via the PUSCH, if the result of judgment in step 1006 is negative;

wherein, the UCI containing the aperiodic CSI may be transmitted together with the uplink data to the base station via the PUSCH in a multiplexing manner; that is, the UCI transmitting the aperiodic CSI uses part of the resources of the uplink data, and this part of resources needs no additional indication via signalling and may be the resources used in such a case agreed in advance between the UE and the base station.

The above embodiment is described taking a plurality of downlink CCs as an example. If the number of the downlink CCs is 1, in step 1006, the condition for judgment is whether it is satisfied that the index number of the MCS is 29 and the number of the RBs, i.e. L1, is less than or equal to 4. Other processes are similar to those shown in FIG. 10, and shall not be described herein any further.

An embodiment further provides a computer-readable program, wherein when the program is executed in a base station, the program enables the computer to carry out the method for transmitting channel state information as described in embodiments 1, 2, 3 or 7 in the base station.

An embodiment further provides a computer-readable program, wherein when the program is executed in a base station, the program enables the computer to carry out the method for transmitting channel state information as described in embodiments 1, 2, 3 or 7 in a base station.

An embodiment further provides a computer-readable program, wherein when the program is executed in UE, the program enables the computer to carry out the method for transmitting channel state information as described in embodiment 4 or 7 in the user equipment.

An embodiment further provides a storage medium in which a computer-readable program is stored, wherein the computer-readable program enables the computer to carry out the method for transmitting channel state information as described in embodiment 4 or 7 in UE.

It can be seen from the above embodiment that the base station may use a bit of downlink control information for uplink transmission in a UE-specific search space, such as a NDI in the DCI format 0 or DCI format 4, and a bit of an aperiodic channel quality indication (A-CQI) request, to transmit indication information, so that the UE transmits the aperiodic CSI according to the indication information, thereby using effectively the unused bits in the DCI format 0 or DCI format 4, and improving the flexibility of carrier configuration. Furthermore, corresponding reporting modes may be configured, so as to reduce overhead of high-layer signaling.

The above apparatuses and methods may be implemented by hardware, or by hardware in combination with software. Certain embodiments relate to such a computer-readable program that when the program is executed by a logic device, the logic device is enabled to carry out the apparatus or components as described above, or to carry out the methods or steps as described above. Certain embodiments relate to a storage medium for storing the above program, such as a hard disk, a floppy disk, a CD, a DVD, and a flash memory, etc.

The present invention is described above with reference to particular embodiments. However, it should be understood by those skilled in the art that such a description is illustrative only, and not intended to limit the protection scope of the present invention. Various variants and modifications may be made by those skilled in the art according to the spirits and principle of the present invention, and such variants and modifications fall within the scope of the present invention.

1. A method for transmitting channel state information, comprising:
generating by a base station control information for uplink transmission in a user equipment specific search space, the control information comprising indication information indicating the user equipment whether to report aperiodic channel state information of related downlink component carriers, and indicating the index number(s) and number of the related downlink component carriers when reporting the aperiodic channel state information of the related downlink component carriers, the index number of modulation and coding scheme and the used resource; wherein the indication information is borne by the bit of a new data indicator in the control information and the bit of an aperiodic channel quality indication request; and
transmitting by the base station the control information to the user equipment such that the user equipment transmits the aperiodic channel state information according to the indication information, the index number of modulation and coding scheme and the used resource contained in the control information.

2. The method according to claim 1, wherein the method further comprises:
configuring by the base station for the user equipment plural groups of sets of the related downlink component carriers;
storing correspondingly the indication information and the plural groups of sets of the related downlink component carriers; and
selecting by the base station corresponding indication information according to the index number(s) and number of the related downlink component carriers when the base station generates the control information.

3. The method according to claim 1, wherein the indication information further comprises a reporting mode of the aperiodic channel state information, or when the number of the related downlink component carriers is more than 1, comprises a reporting mode of the aperiodic channel state information corresponding to the related downlink component carriers.

4. The method according to claim 3, wherein the method further comprises:
configuring by the base station for the user equipment plural groups of sets of the related downlink component carriers and corresponding reporting modes;
storing correspondingly the indication information and the plural groups of sets of the related downlink component carriers and corresponding reporting modes; and
selecting by the base station corresponding indication information according to the index number(s), number and reporting modes of the related downlink component carriers when the base station generates the control information.

5. The method according to claim 3, wherein the bit of the new data indicator and the bit of an aperiodic channel quality indication request are respectively used to indicate the related downlink component carriers and the reporting modes of the aperiodic channel state information.

6. The method according to claim 1, wherein the base station configures for the user equipment the used resource according to the number of the related downlink component carriers.

7. A method for transmitting channel state information, comprising:
receiving by user equipment control information for uplink transmission in a user equipment specific search space transmitted by a base station, the control information comprising indication information indicating the user equipment whether to report aperiodic channel state information of related downlink component carriers, and indicating the index number(s) and number of the related downlink component carriers when reporting the aperiodic channel state information of the related downlink component carriers, the index number of modulation and coding scheme and the used resource; wherein the indication information is borne by the bit of a new data indicator in the control information and the bit of an aperiodic channel quality indication request; and
transmitting by the user equipment the aperiodic channel state information according to the indication information and the index number of modulation and coding scheme and the used resource contained in the control information.

8. The method according to claim 7, wherein the transmitting by the user equipment the aperiodic channel state information according to the indication information and the index number of modulation and coding scheme and the used resource contained in the control information comprises:
reading the indication information by the user equipment according to a predetermined order and judging whether the aperiodic channel state information of the related downlink component carriers needs to be reported according to the indication information;
determining by the user equipment the index number(s) and number of the related downlink component carriers according to the indication information and a prestored corresponding relationship between the indication information and a set of the downlink component carriers, if the judging result is that the aperiodic channel state information needs to be reported;
judging whether to transmit uplink data when the aperiodic channel state information is transmitted according to the determined number of the related downlink component carriers, the corresponding index number of the modulation and coding scheme and the used resource;
transmitting the aperiodic channel state information by the user equipment at the used resource configured by the base station for the user equipment, if the judging result is that the uplink data is not transmitted when the aperiodic channel state information is transmitted; and
transmitting the aperiodic channel state information and the uplink data by the user equipment at the resource configured by the base station for the user equipment, if the judging result is that the uplink data is also transmitted when the aperiodic channel state information is transmitted.

9. The method according to claim 7, wherein the indication information further comprises a reporting mode of the aperiodic channel state information, or comprises a reporting mode of the aperiodic channel state information corresponding to the related downlink component carriers; and
the transmitting by the user equipment the aperiodic channel state information according to the indication information, the index number of modulation and coding scheme and the used resource contained in the control information comprises:
reading the indication information by the user equipment according to a predetermined order and judging whether the aperiodic channel state information of the related downlink component carriers needs to be reported according to the indication information;
determining by the user equipment the index number(s), number of the related downlink component carriers and reporting modes according to the indication information and a prestored corresponding relationship among the indication information, a set of the downlink component carriers and corresponding reporting mode, if the judging result is that the aperiodic channel state information needs to be reported;
judging whether to transmit uplink data when the aperiodic channel state information is transmitted according to the determined number of the related downlink component carriers, the corresponding index number of the modulation and coding scheme and the used resource;
transmitting the aperiodic channel state information according to the reporting mode by the user equipment at the used resource configured by the base station for the user equipment, if the judging result is that the uplink data is not transmitted when the aperiodic channel state information is transmitted; and
transmitting the aperiodic channel state information and the uplink data according to the reporting mode by the user equipment at the resource configured by the base station for the user equipment, if the judging result is that the uplink data is also transmitted when the aperiodic channel state information is transmitted.

10. A base station, comprising:
an information generating unit to generate control information for uplink transmission in a user equipment specific search space, the control information comprising indication information indicating the user equipment whether to report aperiodic channel state information of related downlink component carriers, and indicating the index number(s) and number of the related downlink component carriers when reporting the aperiodic channel state information of the related downlink component carriers, the index number of modulation and coding scheme and the used resource; wherein the indication information is borne by the bit of a new data indicator in the control information and the bit of an aperiodic channel quality indication request; and
a first information transmitting unit to transmit the control information to the user equipment such that the user equipment transmits the aperiodic channel state information according to the indication information, the index number of modulation and coding scheme and the used resource contained in the control information.

11. The base station according to claim 10, wherein the base station further comprises:
a first configuring unit to configure for the user equipment plural groups of sets of the related downlink component carriers; and
a first storing unit to store correspondingly the indication information and the plural groups of sets of the related downlink component carriers; and
wherein the information generating unit selects corresponding indication information according to the index number(s) and number of the related downlink component carriers when the information generating unit generates the control information.

12. The base station according to claim 10, wherein the indication information further comprises a reporting mode of the aperiodic channel state information, or when the number of the related downlink component carriers is more than 1, comprises a reporting mode of the aperiodic channel state information corresponding to the related downlink component carriers; and
the base station further comprises:
a second configuring unit to configure for the user equipment plural groups of sets of the related downlink component carriers and corresponding reporting modes;
a second storing unit to store correspondingly the indication information, the plural groups of sets of the related downlink component carriers and corresponding reporting modes; and
wherein the information generating unit is used to select corresponding indication information according to the index number(s), number of the related downlink component carriers and corresponding reporting modes when the information generating unit generates the control information.

13. A user equipment, comprising:
an information receiving unit to receive control information for uplink transmission in a user equipment specific search space transmitted by a base station, the control information comprising indication information indicating the user equipment whether to report aperiodic channel state information of related downlink component carriers, and indicating the index number(s) and number of the related downlink component carriers when reporting the aperiodic channel state information of the related downlink component carriers, the index number and the used resource of modulation and coding scheme; wherein the indication information is borne by the bit of a new data indicator in the control information and the bit of an aperiodic channel quality indication request; and
a second information transmitting unit to transmit the aperiodic channel state information according to the indication information and the index number of modulation and coding scheme and the used resource contained in the control information.

14. The user equipment according to claim 13, wherein the indication information further comprises a reporting mode indicating the aperiodic channel state information, or when the number of the related downlink component carriers is more than 1, comprises a reporting mode indicating the aperiodic channel state information corresponding to the related downlink component carriers.

15. A computer-readable medium embodying a program, wherein when the program is executed in a base station, the program enables a computer to carry out the method of claim 1.

16. A storage medium in which a computer-readable program is stored, wherein the computer-readable program enables a computer to carry out the method of claim 1.

17. A computer-readable medium embodying a program, wherein when the program is executed in user equipment, the program enables a computer to carry out the method of claim 7.

18. A storage medium in which a computer-readable program is stored, wherein the computer-readable program enables a computer to carry out the method of claim 7.
